(19) United States
(12) Patent Application Publication
(10) Pub. No.: US 2010/0311008 A1
(43) Pub. Date: Dec. 9, 2010

(54) ORAL TONGUE POSITIONING DEVICE

(76) Inventors: Mikael Par Gellerfors, Stockholm (SE); Par Lars Gellerfors, Lidingo (SE)

Correspondence Address: YOUNG & THOMPSON, 209 Madison Street, Suite 500, Alexandria, VA, 22314, US

(21) Appl. No.: 12/864,666

(22) PCT Filed: Jan. 28, 2009
(86) PCT No.: PCT/SE09/50085

§ 371 Date: Jul. 27, 2010

(30) Foreign Application Priority Data
Jan. 31, 2008 (SE) 0800234-7

(51) Int. Cl. A61C 17/14

(52) U.S. Cl. 433/93

(57) ABSTRACT

The invention relates to a device for positioning the tongue for the treatment of disorders including snoring and obstructive sleep apnoea (OSA) and OSA Syndrome, comprising an anchoring body (10) and means (13, 14, 15, 16, 17, 18) for retracting the tongue, said means being connected to said anchoring body. The tongue retracting means comprises at least two elongated arms arranged on a respective side of said anchoring body, and extending along different sides of the midline of the tongue. There is also provided a method of preventing Obstructive Sleep Apnea (OSA), comprising attaching tongue retracting means to permanently attached members in the tongue of a patient suffering from OSA at positions posterior of the tongue tip (apex), preferably to the corpus lingua and/or tongue root (radix lingua), said retracting means being anchored to structures in the mouth such as the jaws or teeth, whereby the tongue is directly held in a forward position.

The present invention relates to devices for the treatment of sleep related disorders, including snoring and obstructive sleep apnoea.

### BACKGROUND OF THE INVENTION

Normally, the muscles of the upper part of the throat keep the airway open to permit air flow into the lungs. When the muscles of the soft palate at the base of the tongue and the uvula relax and sag, the relaxed tissues may vibrate as air flows past the tissues during breathing, resulting in snoring.

In more serious cases, the airway becomes blocked, making breathing laboured and noisy, or even stopping it altogether. Apnoea appears when the upper airway passages are being sucked close to the rear part of the throat when the person is trying to breathe during sleep.

There are several methods and devices presently available for the treatment of snoring and obstructive sleep apnoea. One device is the CPAP (Continuous Positive Airway Pressure) machines. They entail wearing of a mask, headgear, and flexible hose which is attached to the air pump. Although effective, the CPAP machine is not widely accepted by the patients. Discomfort, the sound of the air pump, claustrophobia and the stigma of being seen while wearing the mask, headgear, and hose have all been listed as reasons for not continuing use of the CPAP.

There are oral appliances (OA) which are designed to displace the mandible (lower jaw) or tongue in an anterior (forward) direction. The purpose is to displace the tongue in an anterior direction, to prevent the collapse of the tongue and soft tissues in the back of the throat so that the airway stays open during sleep. These devices have been only partially successful and are not tolerated by a significant percentage of the patients who have them fitted.

Currently, over 40 different types of OAs are available to specially trained dentists to treat sleep disordered breathing. At first glance, this number appears overwhelming but on close examination each of the appliances falls basically into one of two categories and the diverse variety is simply a variation of a few major themes, mandibular repositioning appliances (MRA) and tongue retaining devices (TRD).

Mandibular repositioning appliances are by far the most numerous type on the market. They all function to reposition and maintain the lower jaw (mandible) in a protruded position during sleep. It is felt that this serves to open the airway by indirectly pulling the tongue forward since the tongue is attached to the lower jaw, by stimulating activity of the muscles in the tongue and making it more rigid, and by holding the lower jaw and other structures in a stable position to prevent opening of the mouth.

The second type of OA is called a tongue-retaining (TR) device (TRD). There are very few TRDs available, but they have been well studied and shown to be effective in many patients. TRDs comprise two fused splints with an elastic sleeve or bulb sandwiched between them. The patient inserts his or her tongue into the sleeve, which holds the tongue in the forward position. When the tongue is in a forward position, the back of the tongue does not collapse during sleep and obstruct the airway in the throat.

The patent literature discloses numerous devices for tongue retaining. Among such devices for attempts to inhibit snoring and OSA (Obstructive Sleep Apnea).

OSA is an intermittent, complete or partial, upper airway obstruction during sleep with a somnographic value of AI≧5 (AI=Apnea index; average number of apneas/hour of sleep) or AHI≧10 (AHI=Apne/hypopnea index; average number of apneas and hypopneas/hour of sleep).

U.S. 2007/0163603 A1 discloses a method and device for holding a tongue in a forward position. The tongue positioning device works by securing “an attachment device, such as a tongue piercing or implant located in the tongue”, to the rest of the device. Because the attachment device is located in the tongue, the tongue is maintained in a forward position such that it will not fall back into the throat of the wearer when the attachment device is secured to the rest of the device. According to claim 1 the tongue attachment part of the tongue retaining device comprises of “an attachment device located in a person's tongue”. Only the use of one single tongue hole and one single tongue attachment is described.

U.S. Pat. No. 6,408,851 B1 discloses a method and device for holding a tongue in a forward position. The device works by piercing a hole in the users tongue and then placing a releasable fastener through the tongue hole and thereby affixing the tongue to the rest of the device putting the tongue forward and preventing obstruction of airflow. Only the use of one single tongue hole and one single tongue attachment is described.

Since the lingual frenulum and other inferior tongue tissue parts runs under the mid and posterior part of the tongue, a single tongue attachment part of the device must be connected to the tongue tip (anterior part of the tongue). This is also shown very apparent on the figures of the devices U.S. Pat. No. 6,408,851 B1 and US2007/01663603A1. That is, a single tongue attachment can for anatomical reasons not be attached to the mid and/or posterior part of the tongue. Devices attached to the tongue tip are less effective due to the tongue stretch potential. Furthermore prior art has a highly limited tongue positioning capacity due tongue attachment already so close to the teeth. Additionally one tongue attachment (piercing/bar etc) offers less surface contact with the tongue tissue than two tongue attachments (piercings/bars etc). Furthermore, directly attaching the device to a piercing hole in the tongue can be very hard for elder people.

### SUMMARY OF THE INVENTION

While the prior art devices represent attempts to solve the snoring and apnoea problems, they are rather uncomfortable for the wearer, and they do not appear convincing with respect to their capability of achieving an effective and long-lasting anti-snoring and anti-OSA syndrome effect.

Thus, the need remains for a simple device for reducing or preventing snoring and obstructive sleep apnoea, without the disadvantages of current tongue-retaining devices and mandibular repositioning appliances. The present invention provides such a device, which is defined in claim 1.

In particular the device according to the invention comprises two or more tongue retracting means extending preferably along each side of the tongue midline (sulcus medianus lingua) when the device is mounted. Said retracting means preferably connect to one or more permanent members attached to the tongue, for example sutures, at positions posterior of the tongue apex. that is tongue posterior of the linguae frenulum.

### BRIEF DESCRIPTION OF THE DRAWINGS

FIG. 1A illustrates a prior art device in a perspective view;

FIG. 1B illustrates the device of FIG. 1A attached to a tongue;

FIG. 2A shows a device according to the invention in a perspective view;

FIG. 2B shows the device of FIG. 2A from below;

FIG. 3 illustrates how the tongue collapses into the pharynx when a patient falls asleep, causing snoring and OSA syndrome;

FIG. 4 shows the invention in a mounted state;

FIG. 5 shows the same situation as FIG. 3 but with certain parts of the tongue indicated with arrows.

### DETAILED DESCRIPTION OF THE INVENTION

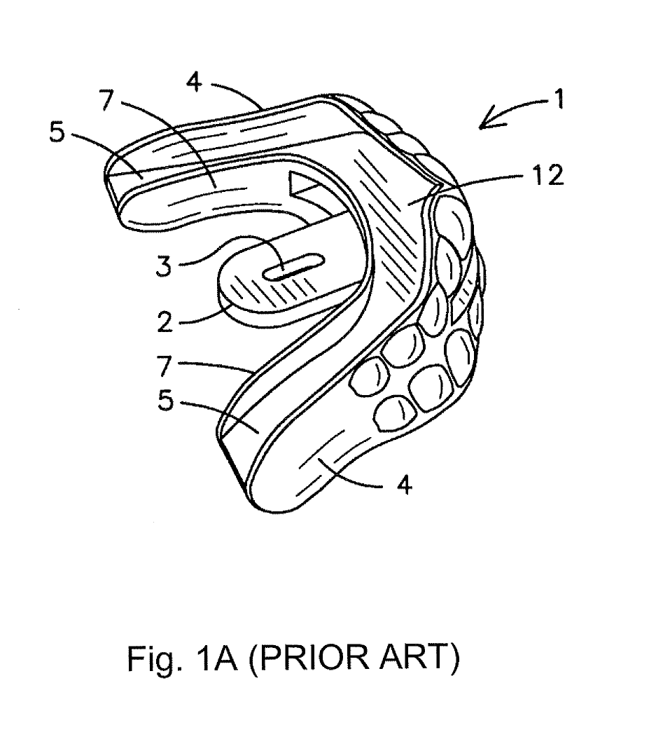

FIGS. 1A and B shows a prior art device in isolation and in position anchored to a tongue, respectively. FIG. 1A shows a perspective view of a tongue retention device 1 of the prior art device. The tongue retention device 1 includes an anchoring piece 12 having a tab 2 secured thereto. The tab 2 includes at least one aperture 3 of a predetermined size. The at least one aperture 3 is predeterminedly-sized so as to accept an attachment device 9. The anchoring piece 12 includes a first wall 4 and a second wall 7 having a channel 5 located therebetween for the acceptance of a person's teeth. The tongue retention device 1 is preferably made of a rubber or soft plastic material so as to mold to and fit comfortably within a person's mouth. In addition, if the tongue retention device 1 is constructed of a rubber or soft plastic, the device 1 may also assist in the prevention of teeth grinding while sleeping. In addition, the tab 2 may be removably insertable into the tongue retention device 1 so as to permit a user to selectively secure his/her tongue in a predetermined position.

FIG. 1B shows a perspective view of the prior art device in use. The attachment device 9 is secured through the aperture 3 of the tab 2 such that the attachment device 9 does not readily slip into or fall out of the aperture 3.

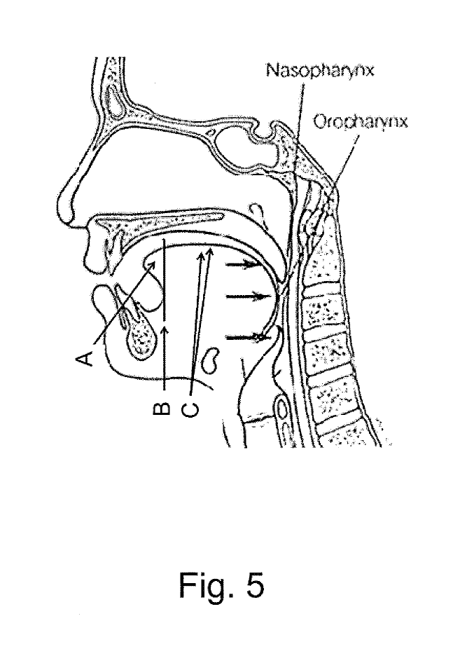

As clearly demonstrated by FIG. 1B the prior art invention can not, due to anatomical reasons, be attached to a tongue position posterior to the frenulum lingua (posterior of line 2 in FIG. 5), that is it can only be attached to the most anterior part of the tongue which is not attached to the mouth bottom

The present invention functions by directly holding the tongue in a forward position. This is achieved by attaching retracting means to the tongue at a position about midway between the tip of the tongue and the tongue root (radix lingua). At the other end the retracting means are anchored to one or more structures like for example the teeth of the upper and/or lower jaw and/or the upper and/or lower jaw. The forward positioning of the tongue prevent occlusion of the airway passage in the pharyngeal space during sleep. That is when the tongue is in this forward position, the back of the tongue does not collapse during sleep and obstruct the airway in the throat. The invention provides for movement of the tongue, into positions in which snoring and/or obstructive sleep apnoea events cannot occur.

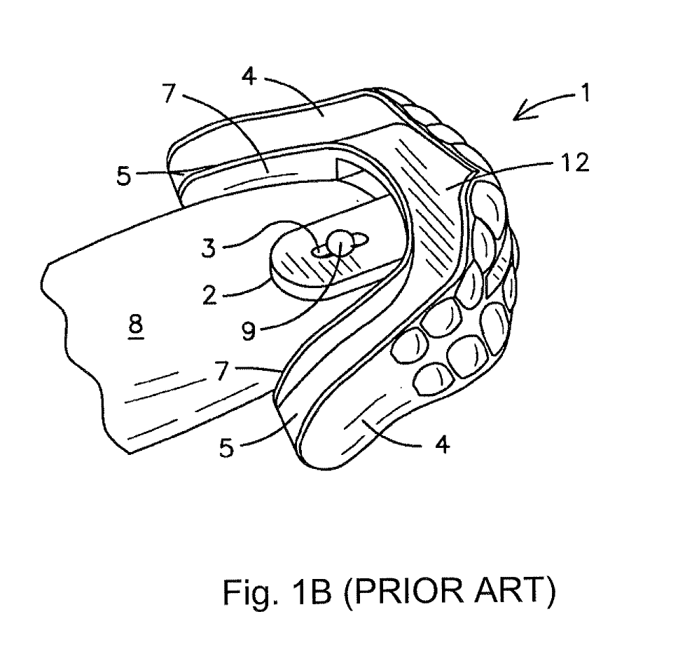

An at present preferred embodiment of the device according to the invention is shown in FIGS. 2A-B. It comprises an anchoring body 10 designed to interact with the teeth of a patient so as to form a fixed point of anchoring. It further comprises two tongue retracting means 13, 14, suitably in the form of elongated legs, suitably having attachment hooks. Other attachment means are possible as long as they achieve the function of securely attaching to the tongue. The legs are attached with their proximal ends to the anchoring body 10. These retracting means 13, 14 extend essentially in parallel to each other or at a slight angle a with respect to the longitudinal direction (indicated in FIG. 2B with a broken line). In FIG. 2B this angle a is approximately 15°, although it can be anywhere between 0°-30°, such as less than 25°, less than 20° or larger than 5°, suitably larger than 10°. 0° represents a parallel situation and negative angles would then correspond to retracting means being attached at a position corresponding to the very mid position and extending backwards into the mouth and slightly “outwards” towards the cheek.

At the distal end (i.e. the end facing inwards in use; “posterior end”) the retracting means preferably are provided with hooks 15,16 for enabling attachment to structures provided in the tongue.

The length of the retracting means 13, 14 is important. They should be long enough such that they can be conveniently attached at a position relatively far inside the mouth, but short enough that they will retract the tongue sufficiently when the anchoring body is positioned in its operative position.

The length will be depending on the size of the tongue, the size of the mandible, other anatomical differences and age of the patient. Thus, children would have smaller devices with accompanying shorter retracting means, whereas adults would have longer ones.

It has turned out that a suitable connection position on the tongue (via permanently attached members) is about midway between the tongue tip and the tongue root, for example about 30-60 mm posterior of the tongue tip (apex).

As the tongue is an elastic tissue it is better the further back (posterior) a device can be attached to the tongue.

In preferred embodiments the retracting means can be replaceable, such that longer means can be replaced by shorter means, as the OSA Syndrome disease progress and further tongue positioning efficacy is necessary. The retracting can also be adjusted for each patient to achieve the best efficacy and comfort. If the replaceable means are provided as pins or pegs of solid material (metal, plastics or the like) they could be provided with threads mating with threaded holes in the anchoring body in order to facilitate the replacement.

An adjustable retracting means can be obtained by providing a thread or string which is anchored in the anchoring body, and which is slightly oversized. In order to shorten the string there can be provided a friction locking means on the anchoring body that will firmly hold the string. Of course there are numerous other options available to the skilled man. If the retracting means are made of threads, strings or rubber, individual adjustment of the tongue positioning could be achieved by adjusting the length of the threads mating with threaded holes in the anchoring body.

In preferred embodiments the hooks are provided with a small ball 17, 18 at the end of the hook.

The attaching of the retracting means to the tongue is suitably done none-invasively with a clamp or by other means. More preferably the device is attached to two or more members that are permanently attached to the tongue, i.e that remains in place when the device is removed from the mouth. Such members are exemplified by for example an elastic ring, a non-elastic ring, a clamp or a suture. Suitably these members are attached to the tongue or to the musculus linguales about midway between the tongue tip and the tongue root, for example about 30-60 mm posterior of the tongue tip (apex).

The anchoring body could be fastened to one or more of the natural or artificial teeth. e.g. by making it as dental impression so as to fit the teeth tightly. Other ways to attach the anchoring body to the teeth are conceivable.

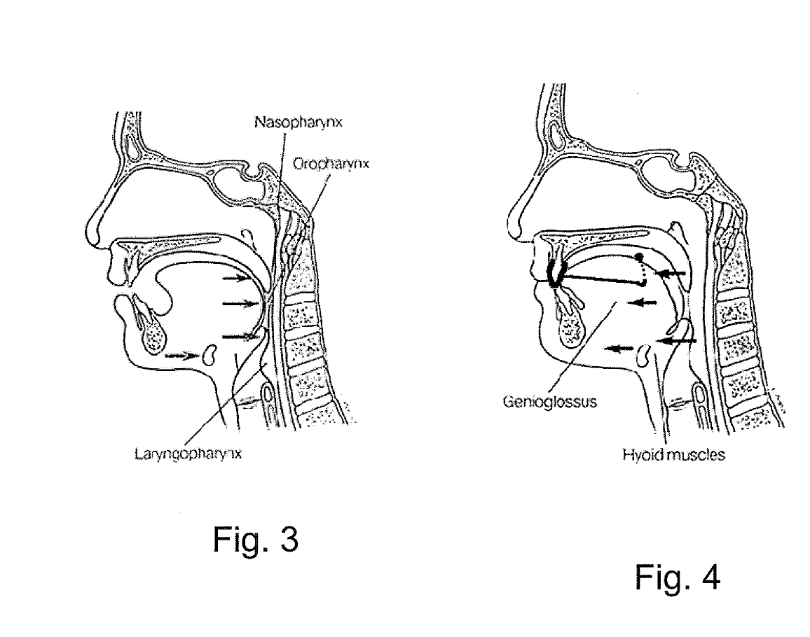

The retracting means being attached to the tongue by one or more permanently provided members, as mentioned above, will cause the tongue to be forced forward providing lessened airway obstruction, since the retracting means are directly or indirectly connected to the anchoring body. Snoring and sleep apnoea is reduced as the tongue is brought forward prohibiting the tissues from falling back and obstructing the airways during sleep. By attaching the anchoring body to the upper teeth (FIG. 4) (or under and upper), also the mandible will be forced forward as the tongue is forced forward and thereby the airway obstruction will be further decreased, reducing the OSA and snoring.

The tongue positioning device is at the other end (i.e. the anchoring body), fixated to the upper and/or lower teeth, other anatomical structures (for example mandible or maxilla etc.), an attachment outside the mouth and/or to another sleep apnoea device (for example oral appliance, mandibular retaining device or continous positive airway pressure (CPAP)) inside or outside the oral cavity.

The different parts of the invention, i.e. the retracting means and the anchoring body, could for example be connected directly or indirectly. The connection could for example consist of a rubber string making it possible to move the tongue a little in different directions making the invention more comfortable to wear.

The retraction means could for example consist of elastic string, non-elastic string, elastic or non-elastic peg or pin etc. At present preferred retraction means consists of slightly elastic threads.

Current tongue retaining devices function by positioning the tip of the tongue in a forward direction. However, the elasticity of the tongue makes prior art TRDs attached to the tongue tip less effective. Contrasting to the prior art tongue tip retaining devices, the invention retains the tongue in a forward position by attaching the device at more than one selected position, for example on each side of the tongue, all positions posterior of the tongue tip. The current invention attaches to the tongue exactly where anterior force is needed, and furthermore the design with two elongated arms makes the tongue stable sideways. The posterior part of the tongue positioning device according to the present invention is fastened at a more posterior location of the tongue than current tongue retaining devices, making it more effective than current tongue retaining devices as for example more of the tongue base is forced forward. The disadvantages of the current tongue positioning devices are hereby eliminated.

With the invention the tongue can be positioned with a greater anterior force and the tongue does not risk to slip out of the device. The invention is more comfortable for the patient to wear, since there is no squeezing pressure on the lateral, superior and inferior part of the tongue. Furthermore there is no need for a patent nasal airway, since the patient can breathe through the mouth making it easier for mouth breathers to wear. Additionally the appearance of the patient is normal, since no foreign body will stick out of the patient's mouth.

As the device is more rigidly fastened in the tongue it will be possible apply a greater anterior directed force. Thereby and because the invention is fastened at a position closer to the base of the tongue it will be possible to treat even severe OSA (AHI>40) with the invention.

The device can also be used to treat all kinds of obstructive sleep apnoea syndrome, obstructive sleep apnoea-hypoapnoea syndrome, upper airway resistance syndrome (UARS) and mild, moderate and/or severe OSA. Further more the device can also be used to treat other conditions and diseases, for example respiratory diseases, neurological diseases and malformations.

The device according to the invention may be made of one or several materials, for example metal, alloy, wood, composite, plastics, rubber and/or glass etc. It should be capable of exerting a sufficient resiliency towards the muscular tension and forces so that it will maintain the anterior position of the tongue.

The device according to the invention could for example be made of a resilient non-toxic plastics material, such as a polyvinyl resin, including a vinyl acetate-ethylene copolymer such as poly(ethyl vinyl acetate), or a polyolefin such as polyethylene or polypropylene. The resilient non-toxic plastics material could be a thermoplastic material, such as a cellulose derivative, a vinyl polymer, a polystyrene, a polyamide, an acrylic resin, etc., which can be shaped to adapt to an individual dentition, for example by heating. The heating could for example be done by moderate heating, such as to a temperature above normal human body temperature, that is, a temperature of at least 40 C. and at the most 80 C., such as at least 50 C. and at the most 80 C., e.g. about 70 C.

The device according to the present invention may be manufactured by plastics moulding, such as cold moulding, compression moulding, injection moulding, etc.

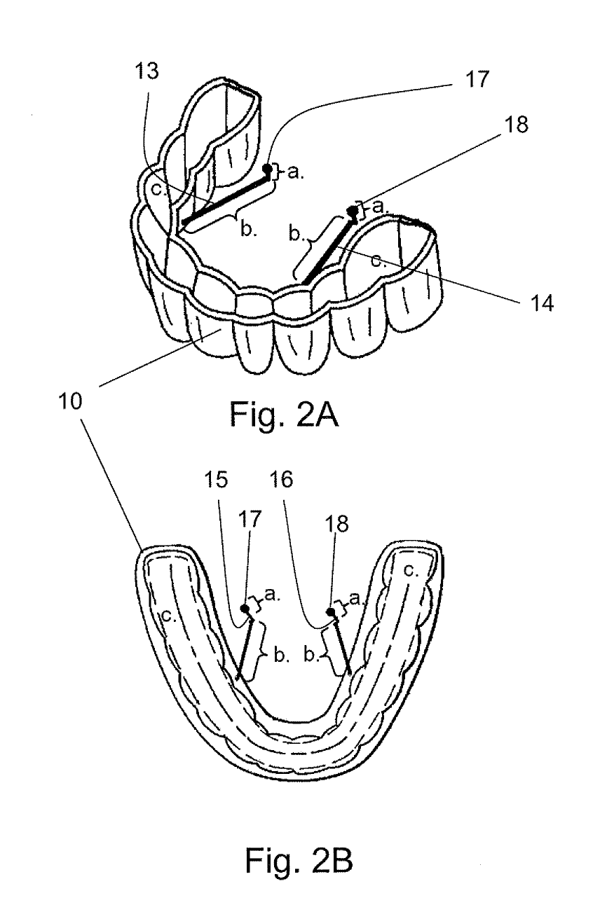

FIG. 3 shows the tongue collapsing into the pharynx when the patients falls asleep, causing snoring and OSA syndrome.

FIG. 4 shows the device according to the invention in operative position. The retracting means of the device are attached to the permanently attached members of the tongue by means of a hook, ring, claw and/or ball or other suitable member. The anchoring body is fastened to the upper and/or lower teeth. Since the retracting means and the anchoring body are connected, the tongue does not collapse backward when the patients falls a sleep. Thereby snoring and OSA syndrome are prevented.

FIG. 5 illustrates where on the tongue it is suitable to place said two or more tongue retracting means extending. Preferably this is done along each side of the tongue midline (sulcus medianus lingua). The retracting means preferably connect to one or more permanent members attached to the tongue, for example sutures, at positions posterior of the tongue apex (arrow A), more precisely in the region indicated with arrow C, that is on the tongue posterior of the frenulum lingua (i.e. posterior of line B in FIG. 5).

1-16. (canceled)

17. A device for positioning the tongue for the treatment of disorders including snoring and obstructive sleep apnoea (OSA) and OSA Syndrome, comprising an anchoring body (10) and means (13, 14, 15, 16, 17, 18) for retracting the tongue, wherein the means for retracting the tongue are connected to the anchoring body,
characterized in that
the tongue retracting means comprises at least two elongated members (13, 14, 15, 16, 17, 18) attached to the anchoring body (10),
each of the elongated members comprises attachment means at their distal ends adapted to be releasably engaged with one or more members permanently attached to the tongue or musculus linguales, at positions posterior of the tongue tip (apex), preferably to the corpus lingua and/or tongue root (radix lingua.

18. The device as claimed in claim 17, wherein said retracting means extend essentially in parallel to each other

19. The device as claimed in claim 17, wherein said anchoring body is fastened to one or more of the natural or artificial teeth.

20. The device as claimed in claim 17, wherein said anchoring body is fastened to one or more of the dentes incisive, dentes canini, dentes premolars or dentes molars.

21. The device as claimed in claim 17, wherein said anchoring body clasp, surround or encircle one or more of the surfaces of the teeth.

22. The device as claimed in claim 21, wherein said permanently attached members are selected from elastic rings, non-elastic rings, clamps or sutures.

23. The device as claimed in claim 17, wherein said retracting means are selected from a thread, an elastic string, a non-elastic string, an elastic peg or a non-elastic peg or pin.

24. The device as claimed in claim 17, wherein said retracting means comprise hooks at their distal ends for engaging said mating means permanently attached to the tongue.

25. The device as claimed in claim 17, wherein the retracting means have a variable length.

26. The device as claimed in claim 17, wherein the anchoring body is a dental impression adapted to fit the teeth tightly.

27. The device as claimed in claim 17, wherein said anchoring body is fastened to the upper (maxilla) and/or lower jaw (mandible) and/or another device (for example oral appliance, mandibular retaining device or continous positive airway pressure (CPAP)) inside or outside the oral cavity.

28. The device as claimed in claim 17, wherein said retracting means comprise a ball at their distal ends for engaging said mating means permanently attached to the tongue.

29. The device as claimed in claim 17, wherein the retracting means extend along different sides of the midline of the tongue in a mounted state.

30. A method of preventing Obstructive Sleep Apnea (OSA), comprising attaching tongue retracting means to permanently attached members in the tongue of a patient suffering from OSA at positions posterior of the tongue tip (apex), preferably to the corpus lingua and/or tongue root (radix lingua), said retracting means being anchored to structures in the mouth such as the jaws or teeth, whereby the tongue is directly held in a forward position.

31. The device as claimed in claim 18, wherein said anchoring body is fastened to one or more of the natural or artificial teeth.
